(19) United States
(12) Patent Application Publication
(10) Pub. No.: US 2014/0149871 A1
(43) Pub. Date: May 29, 2014

(54) SERVICE ADDRESS VALIDATION TOOL FOR A SERVICE PROVIDER NETWORK

(71) Applicant: VERIZON PATENT AND LICENSING INC., Basking Ridge, NJ (US)

(72) Inventors: Edward L. Peters, Grapevine, TX (US); Mack Alexander, III, Prosper, TX (US); Jennifer Hayes, Denton, TX (US)

(73) Assignee: VERIZON PATENT AND LICENSING INC., Basking Ridge, NJ (US)

(21) Appl. No.: 13/684,971

(22) Filed: Nov. 26, 2012

(51) Int. Cl. H04L 29/12; G06F 3/01

(52) U.S. Cl. CPC H04L 61/1541; G06F 3/01
USPC 715/736

(57) ABSTRACT

A device receives, from a user, a selection of a geographic region associated with a service provider network. The device generates a map of the geographic region, where the map includes notations of residential and business addresses, service provider network information, and addresses that purportedly are not accessible to the service provider network that potentially are actually accessible to the service provider network. The device presents the map to the user and receives, from the user, an indication that certain of the address that purportedly are not accessible to the service provider network have been determined to actually be accessible to the service provider network, or have been determined to not be accessible to the service provider network. The device revises the service provider network information based on the validation of the one or more addresses.

### BACKGROUND

Communication networks, such as fiber optic cable networks or Public Switched Telephone Networks, often span extensive geographic areas and involve many components spread out over that geographic area for providing network service to numerous customers at residential and business addresses. When components of the service provider network are initially installed in a geographic area, often there are errors in identifying which addresses are, or are not, accessible to the installed local components of the service provider network. Occasionally, addresses are identified as not being accessible to the installed components of the service provider network, when in actuality they may be. Additionally, as residences and business addresses are added or removed from a geographic area, records may not be adequately maintained as to whether those addresses are accessible to the service provider network. When a network service provider identifies certain addresses as not being accessible to the service provider network, than those addresses may be denied network service, resulting in a loss of revenue to the network service provider.

### BRIEF DESCRIPTION OF THE DRAWINGS

FIGS. 1A and 1B are diagrams that depict an overview of the validation of service addresses that are potentially accessible to a service provider network;

FIG. 2 is a diagram that depicts an exemplary environment in which the service address validation of FIGS. 1A and 1B may be implemented;

FIG. 3 is a diagram that depicts exemplary components of the address recovery system of FIGS. 1A and 2;

FIG. 4 is a diagram that illustrates an exemplary data structure that may be stored in the address recovery database of FIG. 2;

FIG. 5 is a flow diagram that illustrates an exemplary process for identifying addresses that potentially are accessible to a service provider network based on a comparison of geographic mapping data and service provider network information;

FIG. 6 is an exemplary messaging diagram associated with the exemplary process of FIG. 5;

FIG. 7 is a flow diagram that illustrates an exemplary process for validating service addresses that have been previously identified as potentially being accessible to a service provider network;

FIG. 8 is an exemplary messaging diagram associated with the exemplary process of FIG. 7; and

FIGS. 9 -20 are diagrams that depict user interface examples associated with the exemplary process of FIG. 7.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

In embodiments described herein, an address recovery system enables a network service provider to “recover” addresses that may have been inadvertently or incorrectly identified as being inaccessible to a service provider network. The address recovery system may obtain and aggregate network related information, including geographic locations of service provider network components, from one or more network information systems. The address recovery system may further obtain geographic mapping data, that includes residential and business address data, from a geographic mapping system, and may compare the geographic mapping data with the aggregated network related information to identify addresses that are purportedly not accessible to the service provider network. The address recovery system described herein enables users, via a user interface, to investigate the addresses identified as purportedly not being accessible to the service provider network. The users may determine whether the addresses are actually accessible to the service provider network so that communication services may be offered to the customers at those addresses. The address recovery system described herein, therefore, permits the network service provider to increase revenue by providing network service to addresses that were incorrectly identified as being inaccessible to the service provider network.

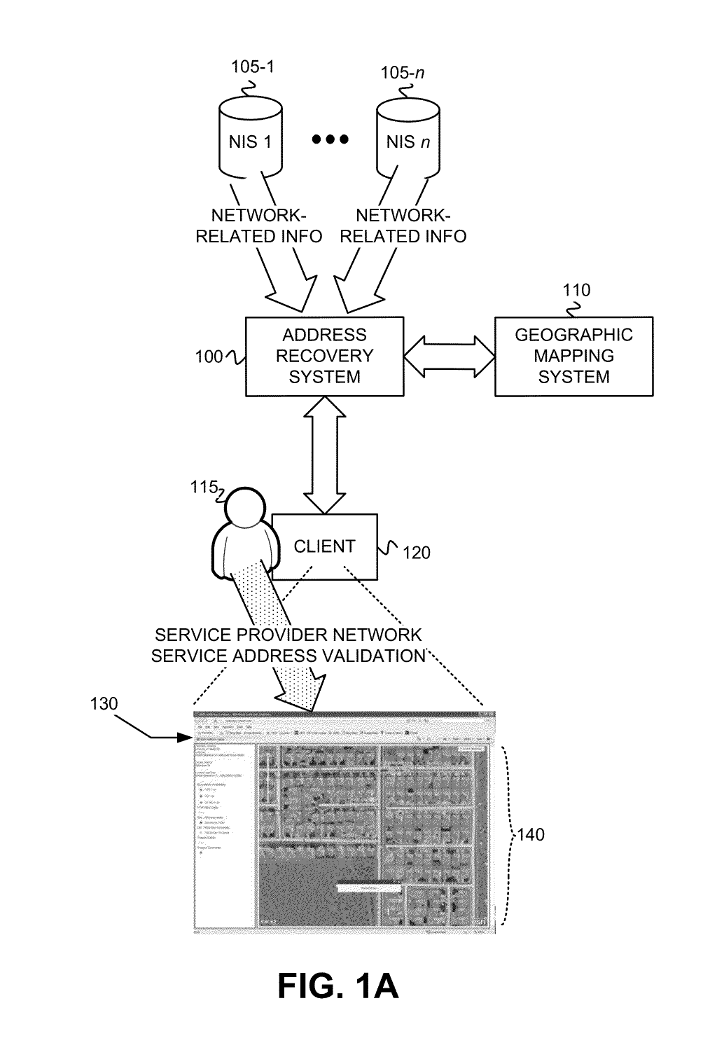

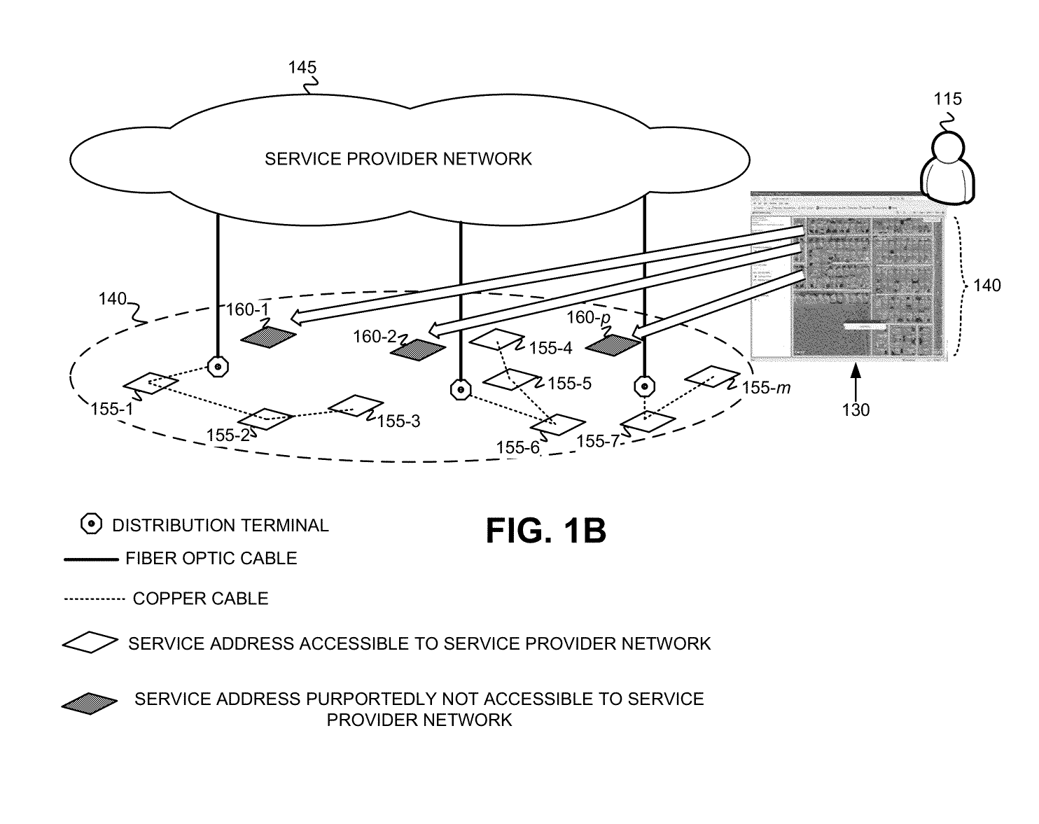

FIGS. 1A and 1B are diagrams that depict an overview of the validation of service addresses that are potentially accessible to a service provider network. A “service provider network,” as referred to herein may include a communication service provider network, such as, for example, a Public Switched Telephone Network (PSTN), or a fiber optic cable network. The “service provider network” may also include other types of communication service provider networks. A “service address,” as referred to herein is a residential or business postal address that may or may not be accessible to the service provider network. “Address validation,” as described herein, refers to a user (e.g., a service provider network employee) employing address recovery system 100 described herein to determine whether or not an address, that has been identified by address recovery system 100 as being potentially accessible to the service provider network, is actually accessible to the service provider network and, therefore, may be connected to the service provider network as a service address receiving billable service.

In order for the validation of service addresses to a service to occur, address recovery system 100 may obtain network related information from one or more external network information systems (NIS) (e.g., databases), such as NIS 105-1 through 105-n, where n≦1. In the case of a fiber optic cable network, the network related information may include fiber optic cabling geographic routing information, distribution hub geographic location information, distribution terminal geographical location information, and copper cabling geographic routing information.

Address recovery system 100 may further obtain geographic mapping information from geographic mapping system 110 that relates to the geographic areas spanned by the service provider network. Address recovery system 100 may compare the network related information obtained from NIS 105-1 through 105-n with the geographic mapping information obtained from geographic mapping system 110 to identify addresses purportedly not accessible to the service provider network that potentially are actually accessible to the service provider network.

A user 115 at a client 120 may access address recovery system 100 via a user interface 130 to retrieve a map of a geographic area 140, upon which is superimposed details of the disposition of components of the service provider network within geographic area 140. User 115 at client 120 may use user interface 130 to validate one or more service addresses within geographic area 140. User 115 at client 120 may validate the one or more service addresses by determining via visual inspection of the map of geographic area 140 and the disposition of components of the service provider network that the one or more service addresses are accessible or not accessible to appropriate components of the service provider network. Alternatively, user 115 at client 120 may validate the one or more service addresses by determining via visual inspect of the map of geographic area 140 and the disposition of components of the service provider network that the one or more service addresses appear to be accessible or not accessible to appropriate components of the service provider network, and may schedule a follow-up manual on-site inspection to verify, firsthand, that the one or more service addresses are actually accessible to the service provider network such that, with the installation of appropriate connecting equipment, the one or more service addresses may connect to the service provider network to receive billable service.

FIG. 1B depicts further details of service address validation within a service provider network 145. As shown, user interface 130, interacting with address recovery system 100 (not shown), may display a map of a geographic area 140 of service provider network 145. The map of geographic area 140 displayed in user interface 130 may depict the components of service provider network 145 that are needed to provide service to addresses, and the disposition of those components within geographic area 140. In the case where service provider network 145 is a fiber optic cable network, the components of service provider network 145 may include distribution terminals (e.g., optical network terminals (ONTs)), fiber optic cables, and copper cables. User interface 130 may depict the disposition of distribution terminals, fiber optic cables, and copper cables in geographic relation to service addresses within geographic area 140. As shown in FIG. 1B, user interface 130 may depict service addresses 155-1 through 155-m that are known to be accessible to service provider network 145, and other service addresses 160-1 through 160-p that are purportedly not accessible to service provider network 145, but may actually be accessible to service provider network 145. User 115, via user interface 130, may analyze the configuration of components of service provider network 145 superimposed on the map of geographic area 140 to validate each of addresses 160-1 through 160-p.

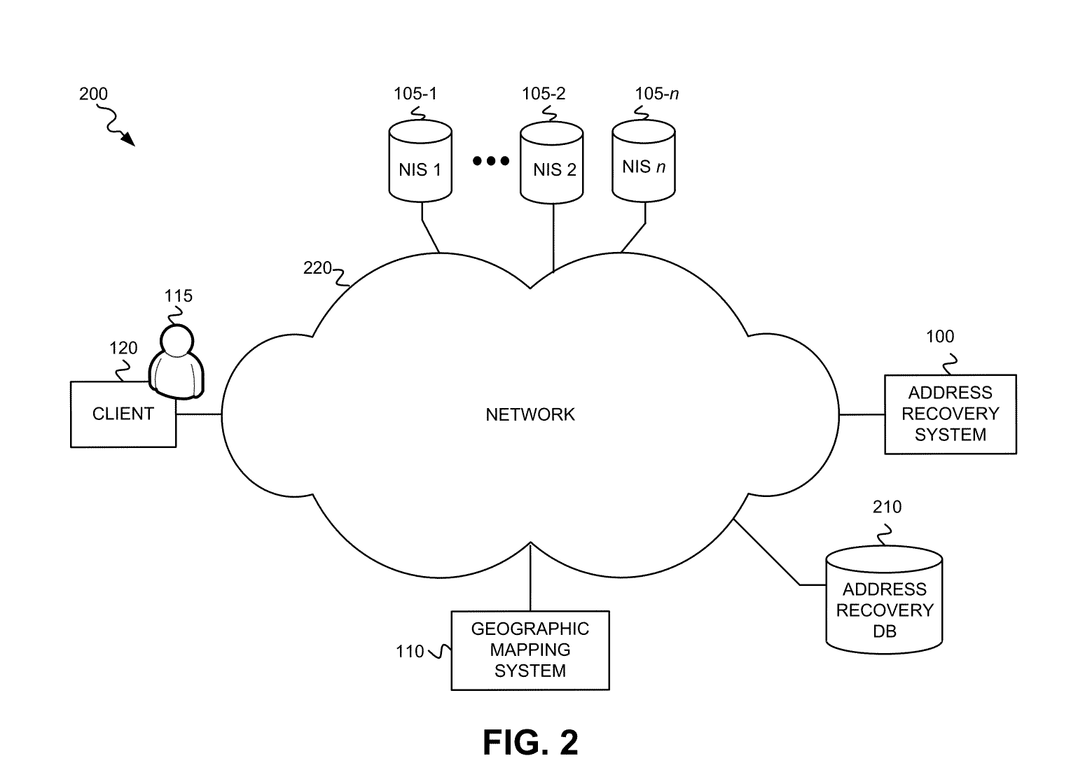

FIG. 2 is a diagram that depicts an exemplary environment 200 in which the service address validation described with respect to FIGS. 1A and 1B may be implemented. Network environment 200 may include address recovery system 100, NIS 105-1 through 105-n, geographic mapping system 110, client 120, address recovery DB 210, and network 220.

Address recovery system 100 may include a network device, such as, for example, a server, that may obtain geographic mapping data from geographic mapping system 110 and network related information from NIS 105-1 through 105-n and may identify addresses that may potentially be accessible to a service provider network based on the obtained mapping data and network related information. Address recovery system 100 may, based on user input, generate maps of geographic regions, where the maps include notations of addresses, service provider network information, and the identified addresses that may potentially be accessible to the service provider network.

NIS 105-1 through 105-n (generically referred to herein as “NIS 105”) may include multiple different devices, servers, clients and/or data structures that may store information related to a service provider network. The network related information may include, for example, geographic locations of various specific components of the network. If the service provider network includes a fiber optic cable network, for example, the network related information may include geographic locations of fiber optic cabling, distribution hubs, distribution terminals (e.g., drop terminals), copper cabling, and copper terminals.

Geographic mapping system 110 may include a network device, such as, for example, a server, that maintains geographic mapping data related to a geographic region. The geographic region may span a limited geographic area (e.g., a state or country), or may span the entirety of the earth. Geographic mapping system 100 may include a commercially available service that is not owned and operated by the network service provider, and which address recovery system 100 merely accesses to obtain geographic mapping data.

Client 120 may include a computational device that further includes network communication capabilities. Client 120 may include, for example, a desktop, laptop, palmtop or tablet computer, a cellular telephone (e.g., smart phone), or a personal digital assistant (PDA). Client 120 may connect to network 220 via wired or wireless links.

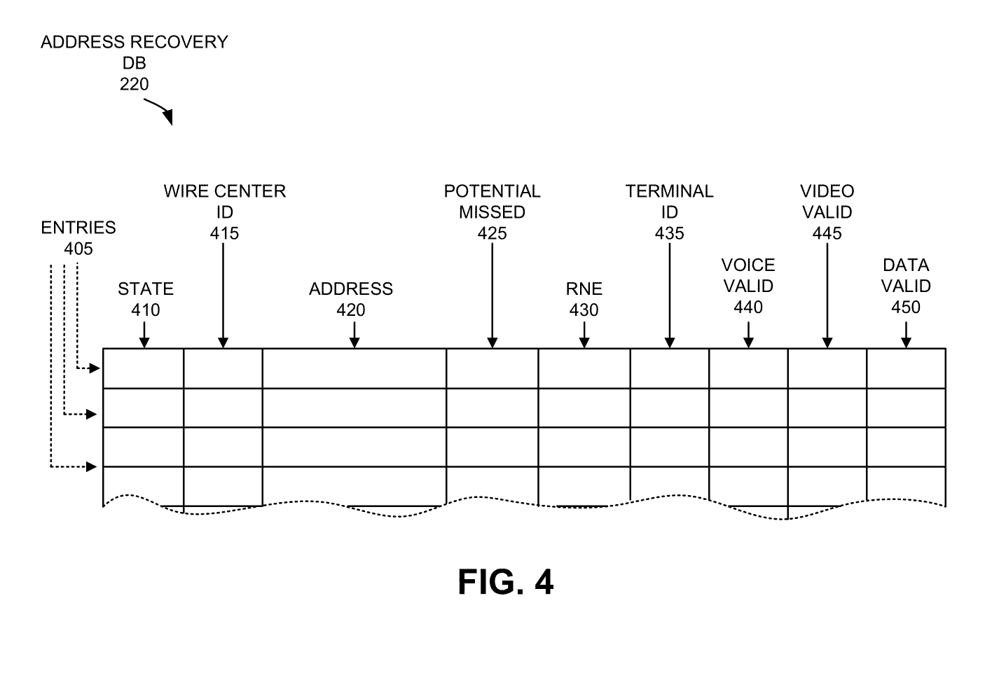

Address recovery DB 210 may include a network device that stores a data structure that further stores various data fields, such as those described with respect to the exemplary data structure of FIG. 4 below. Each entry in the data structure may include an address that may or may not be accessible to a given service provider network. Each entry may further include data related to the state (e.g., Virginia, etc.) that the address is located in, the wire center ID of the wire center of the service provider network that may serve the address, and a terminal ID of a drop terminal of the service provider network that may serve the address. Each entry of the data structure may store additional data, as described with respect to FIG. 4.

Network 220 may include one or more wired or wireless networks, or other types of networks. The wireless networks may include wireless satellite networks and/or wireless public land mobile networks (PLMNs). The PLMN(s) may include a Code Division Multiple Access (CDMA) 2000 PLMN, a Global System for Mobile Communications (GSM) PLMN, a Long Term Evolution (LTE) PLMN and/or other types of PLMNs. The wired networks, or other types of networks, may include a telecommunications network (e.g., a PSTN), a local area network (LAN), a wide area network (WAN), a metropolitan area network (MAN), an intranet, the Internet, or a cable network (e.g., an optical cable network). Network 220 may, or may not, include service provider network 145.

The configuration of network components of network environment 200 shown in FIG. 2 is for illustrative purposes. Other configurations may be implemented. Therefore, network environment 200 may include additional, fewer and/or different components that may be configured in a different arrangement than that depicted in FIG. 2.

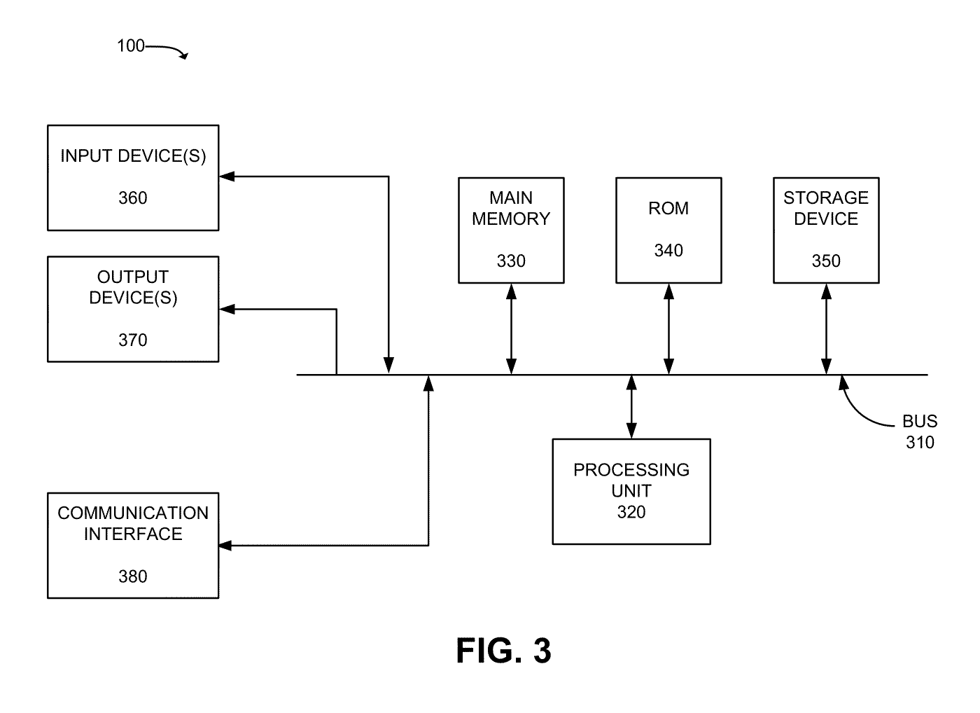

FIG. 3 is a diagram that depicts exemplary components of address recovery system 100. Client 120, geographic mapping system 110, NIS 105-1 through 105-n and address recovery DB 220 may be similarly configured. Address recovery system 100 may include a bus 310, a processing unit 320, a main memory 330, a read only memory (ROM) 340, a storage device 350, an input device(s) 360, an output device(s) 370, and a communication interface 380. Bus 310 may include a path that permits communication among the other components of address recovery system 220.

Processing unit 320 may include one or more processors or microprocessors, or processing logic, which may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium. Main memory 330, ROM 340 and storage device 350 may each be referred to herein as a “tangible non-transitory computer-readable medium.” The process/methods set forth herein can be implemented as instructions that are stored in main memory 330, ROM 340 and/or storage device 350 for execution by processing unit 320.

Input device 360 may include one or more mechanisms that permit an operator to input information to address recovery system 100, such as, for example, a keypad or a keyboard, a display with a touch sensitive panel, voice recognition and/or biometric mechanisms, etc. Output device 370 may include one or more mechanisms that output information to the operator, including a display, a speaker, etc. Input device 360 and output device 370 may, in some implementations, be implemented as a user interface (UI) that displays UI information and which receives user input via the UI. Communication interface(s) 380 may include a transceiver that enables address recovery system 100 to communicate with other devices and/or systems. For example, communication interface(s) 380 may include wired or wireless transceivers for communicating via network 210.

Address recovery system 100 may perform certain operations or processes, as described herein. Address recovery system 100 may perform these operations in response to processing unit 320 executing software instructions contained in a computer-readable medium, such as memory 330. The software instructions may be read into main memory 330 from another computer-readable medium, such as storage device 350, or read into main memory 330 from another device via communication interface 380. The software instructions stored in main memory 330 may cause processing unit 320 to perform operations or processes that are described below. Alternatively, hardwired circuitry may be used in place of or in combination with software instructions to implement processes described herein. Thus, exemplary implementations are not limited to any specific combination of hardware circuitry and software.

The configuration of components of address recovery system 100 illustrated in FIG. 3 is for illustrative purposes. Other configurations may be implemented. Therefore, address recovery system 100 may include additional, fewer and/or different components than those depicted in FIG. 3.

FIG. 4 is a diagram that illustrates an exemplary data structure that may be stored in address recovery database 220. Address recovery database 220 may store a data structure that includes multiple entries 405, each of which may include a state field 410, a wire center identifier (ID) field 415, an address field 420, a potential missed field 425, a Reason Not Engineered (RNE) field 430, a terminal ID field 435, a voice valid field 440, a video valid field 445, and a data valid field 450.

State field 410 stores a unique identifier of a state in which the address identified in field 420 is located. Wire center ID field 415 stores a unique identifier that identifies a specific wire center, which is part of the service provider network and which serves the address identified in field 420.

Address field 420 stores address information (e.g., postal address information) associated with a service address that may receive service from the service provider network. The address information may include, for example, a street address, city and zip code.

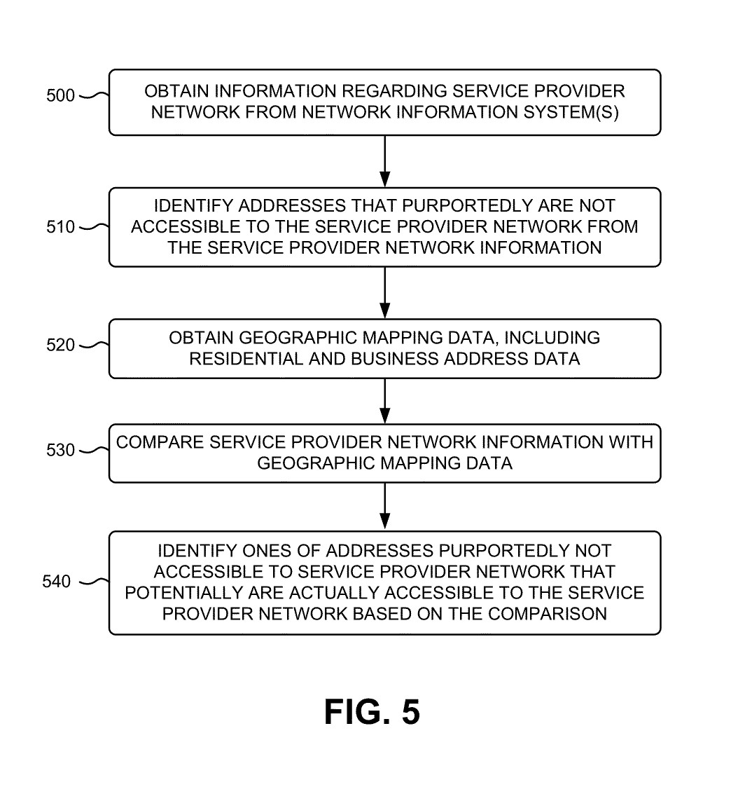

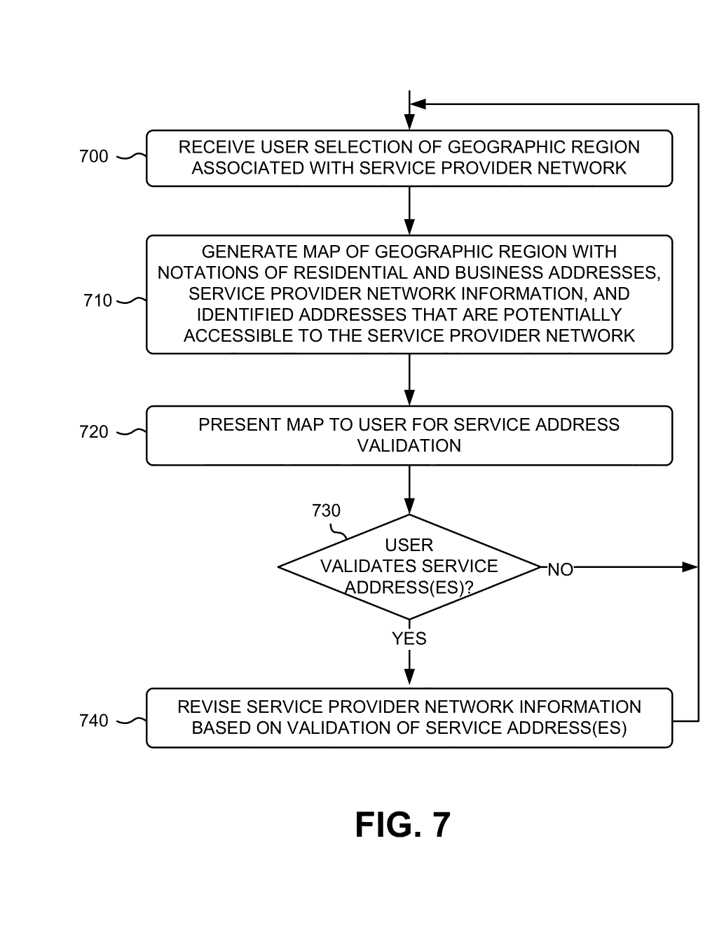

Potential missed field 425 identifies whether the address identified in field 420 has been identified as potentially actually accessible to the service provider network (as identified in block 540 of FIG. 5 below). RNE field 430 stores data that identifies a reason why, after performance of the validation process of FIG. 7, that the address identified in field 420 cannot, or will not, receive access to the service provider network.

Terminal ID field 435 stores a unique identifier that identifies a distribution terminal (e.g., a drop terminal) to which the address identified in field 420 is accessible. Voice valid field 440 indicates whether the address identified in field 420 can receive voice service from the service provider network. Video valid field 445 indicates whether the address identified in field 420 can receive video service from the service provider network. Data valid field 450 indicates whether the address identified in field 420 can receive data service from the service provider network.

The different fields of the data structure of address recovery database 220 shown in FIG. 4 are shown for illustrative purposes only. Other data structure configurations may be implemented. Therefore, the data structure address recovery database 220 may include additional, fewer and/or different fields than those depicted in FIG. 4. Though the data structure of address recovery database 220 has been depicted in table form, other types of data structures may alternatively be used.

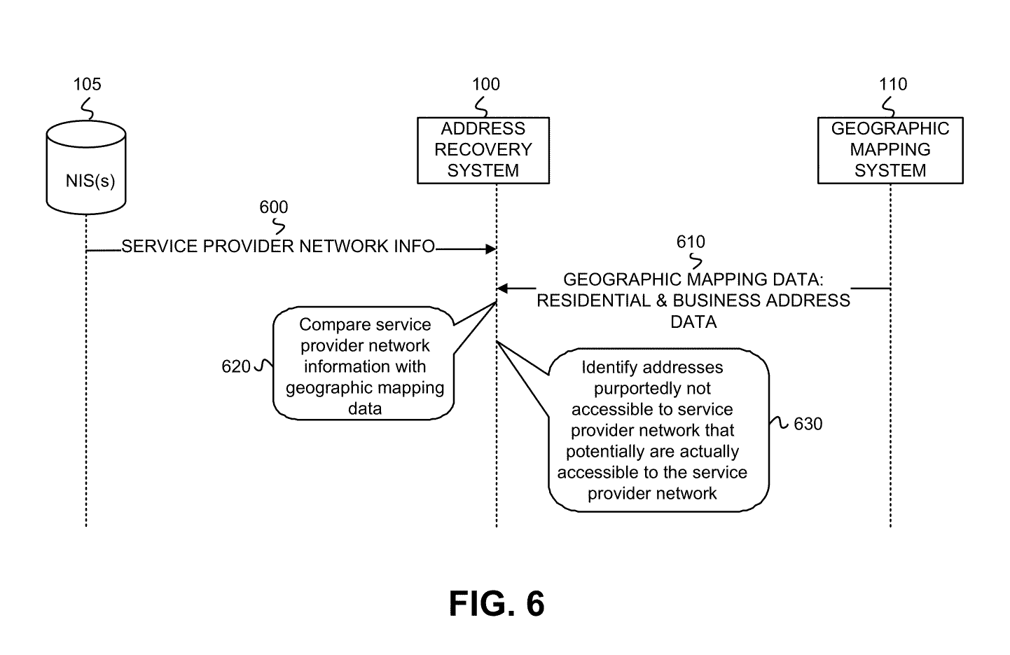

FIG. 5 is a flow diagram that illustrates an exemplary process for identifying addresses that potentially are accessible to a service provider network based on a comparison of geographic mapping data and service provider network information. The exemplary process of FIG. 5 may be implemented by address recovery system 100. The description of the exemplary process of FIG. 5 below refers to the exemplary messaging diagram of FIG. 6. The exemplary process of FIG. 5 may be selectively repeated (e.g., at periodic intervals) to update the service provider network information and the geographic mapping data.

The exemplary process may include address recovery system 100 obtaining information regarding a service provider network from one or more network information systems (block 500). FIG. 6 depicts address recovery system 100 receiving service provider network information 600 from one or more NISs 105. Address recovery system 100 may actively pull the information from NISs 105, or NISs 105 may push the service provider network information out to address recovery system 100 (e.g., on a periodic basis).

Address recovery system 100 may identify addresses that purportedly are not accessible to the service provider network from the service provider network information (block 510). Address recovery system 100 may analyze the service provider network information obtained in block 500 to identify the addresses that purportedly are not accessible to the service provider network. The service provider network information may already have identified addresses within the service provider network that supposedly are not accessible to the service provider network. Address recovery system 100 may obtain geographical mapping data, including residential and business address data (block 520). FIG. 6 depicts address recovery system 100 receiving geographic mapping data 610, including residential and business address data, from geographic mapping system 110. Address recovery system 100 may pull the mapping data from geographic mapping system 110, or geographic mapping system 110 may push the mapping data to address recovery system 100. Address recovery system 100 may, based on blocks 500, 510 and 520, create entries 405 in address recovery DB 220 for each address determined to be within a geographic region served by the service provider network.

Address recovery system 100 may compare the service provider network information with the geographic mapping data (block 530). FIG. 6 depicts address recovery system 100 comparing 620 the received service provider network information 600 with geographic mapping data 610. The comparison may include noting where network components of the service provider network are geographically located in relation to the addresses identified in block 510.

Address recovery system 100 may identify addresses, purportedly not accessible to the service provider network, that potentially are actually accessible to the service provider network based on the comparison of block 520 (block 540). FIG. 6 depicts address recovery system 100 identifying 630 addresses purportedly not accessible to the service provider network that potentially are actually accessible to the service provider network. Addresses identified in block 510 that are within certain physical distances of network components (e.g., drop terminals) noted in block 530 may be identified as potentially being accessible to the service provider network.

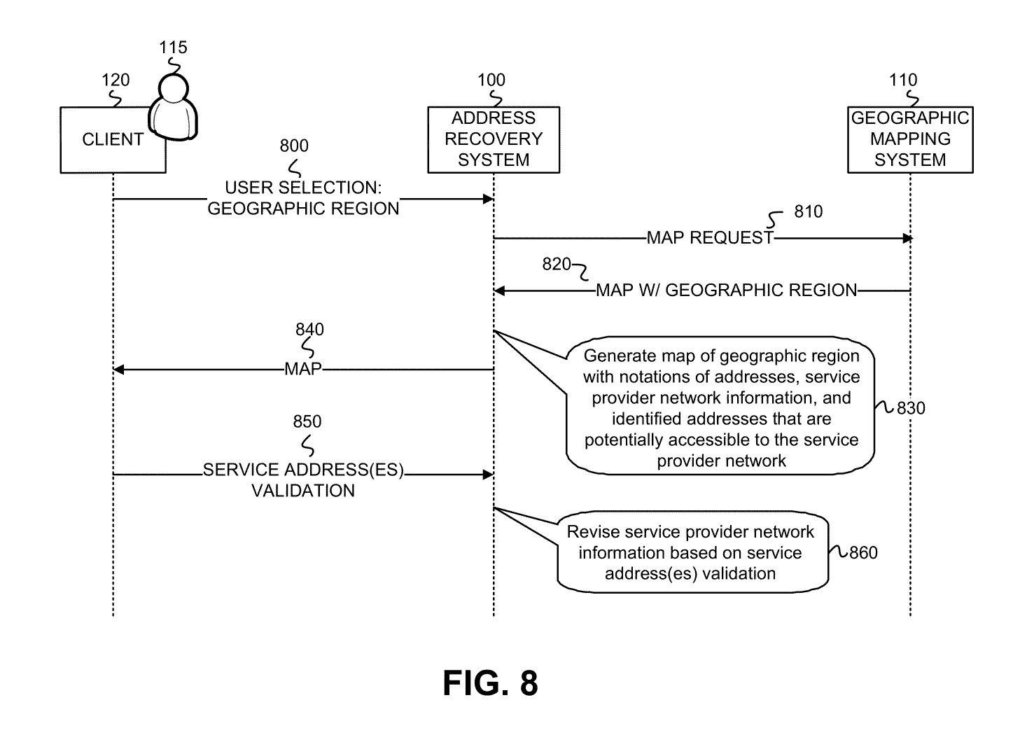

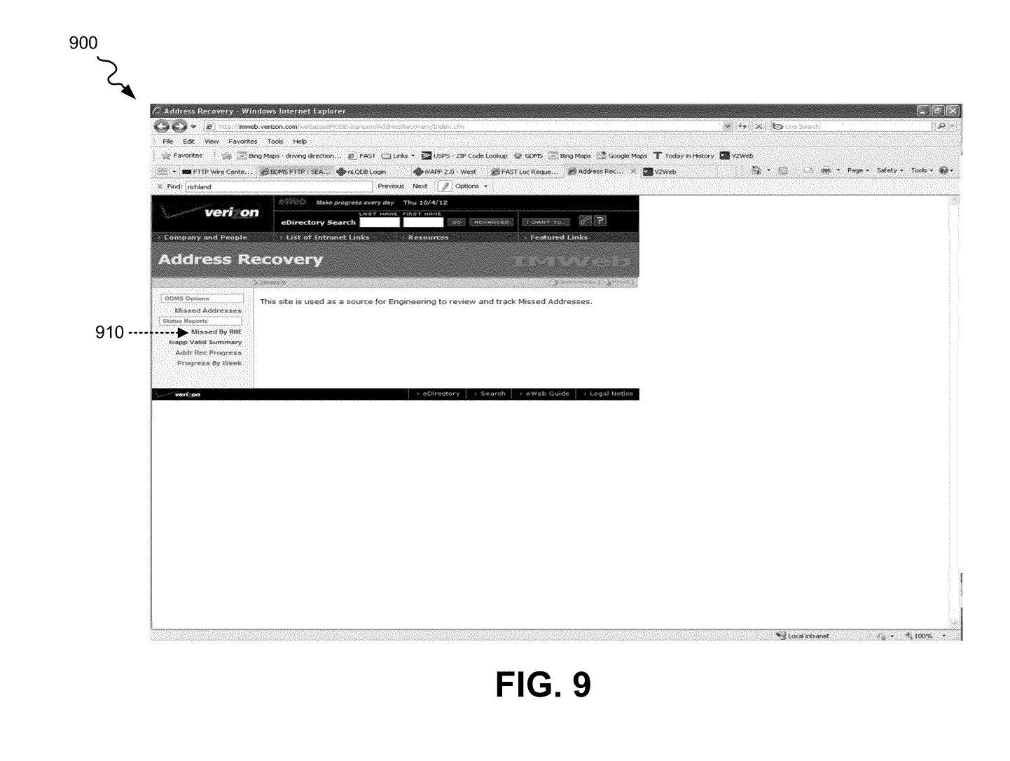

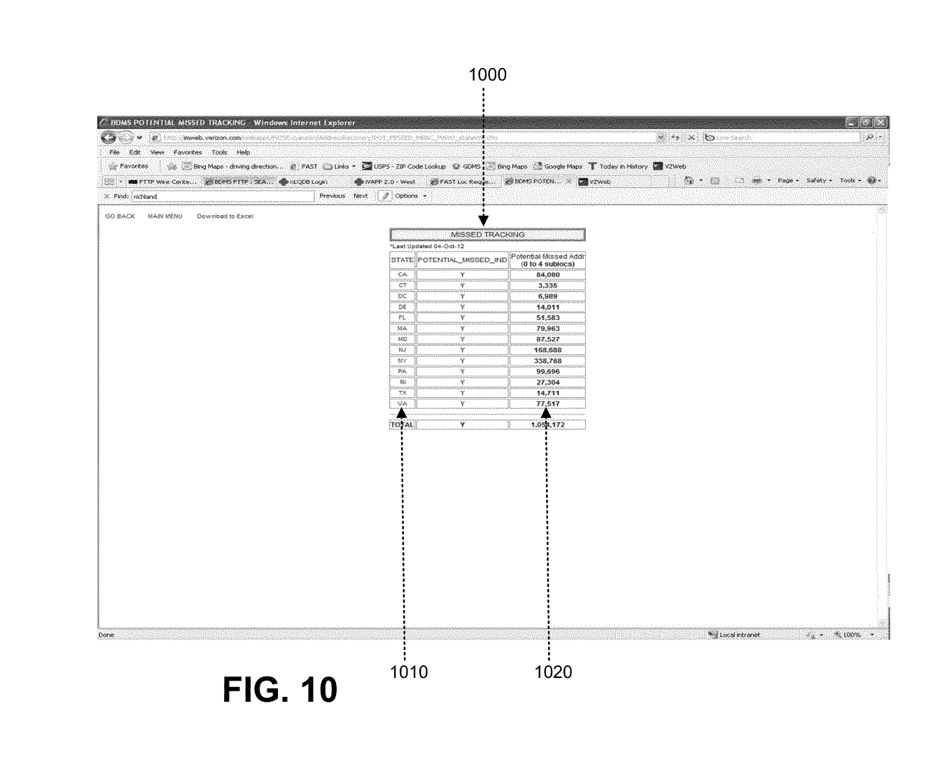

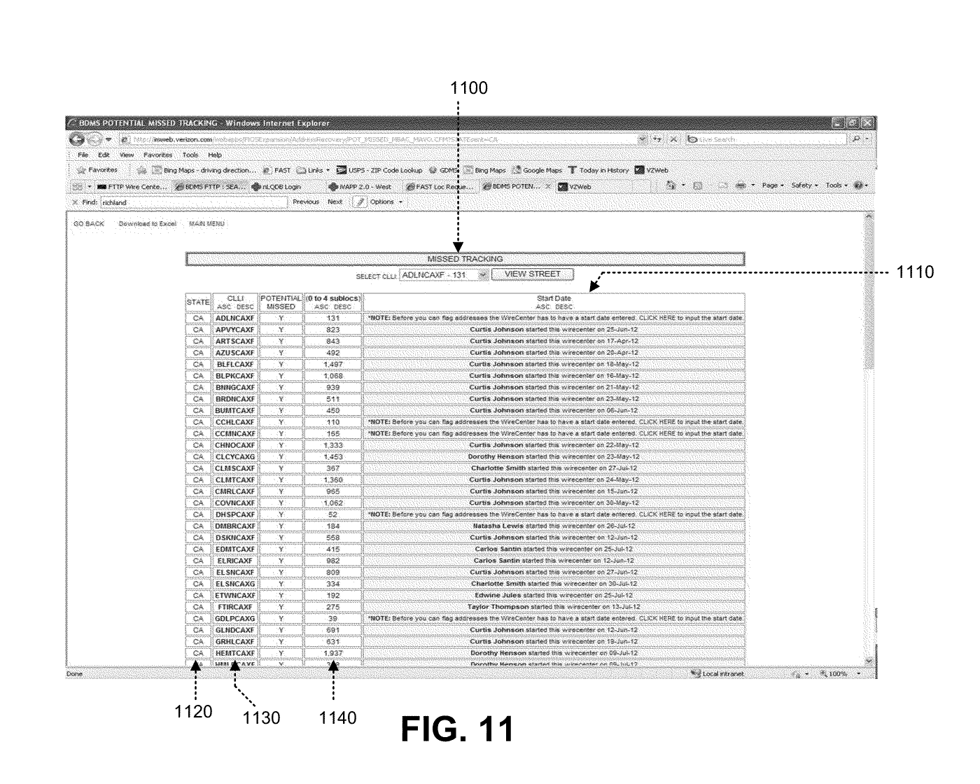

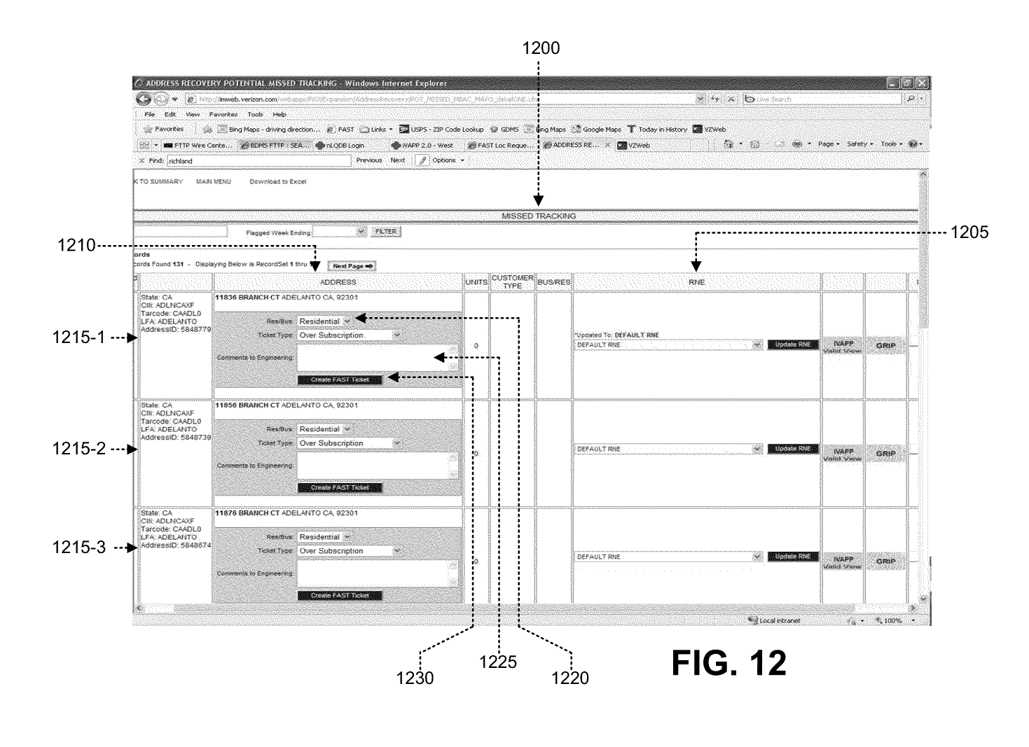

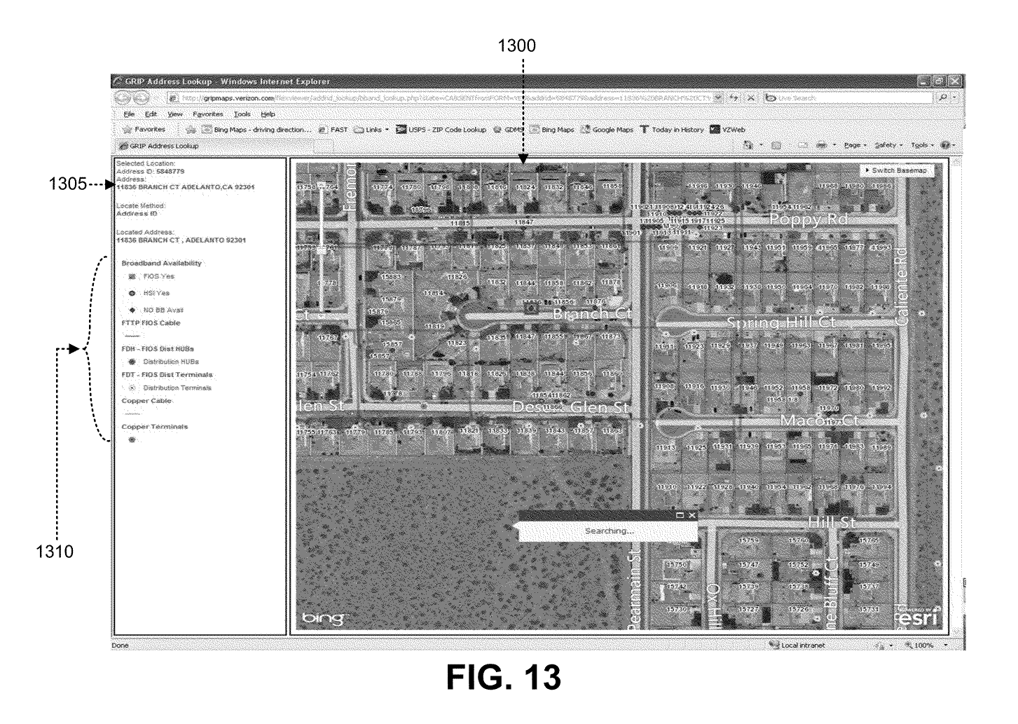

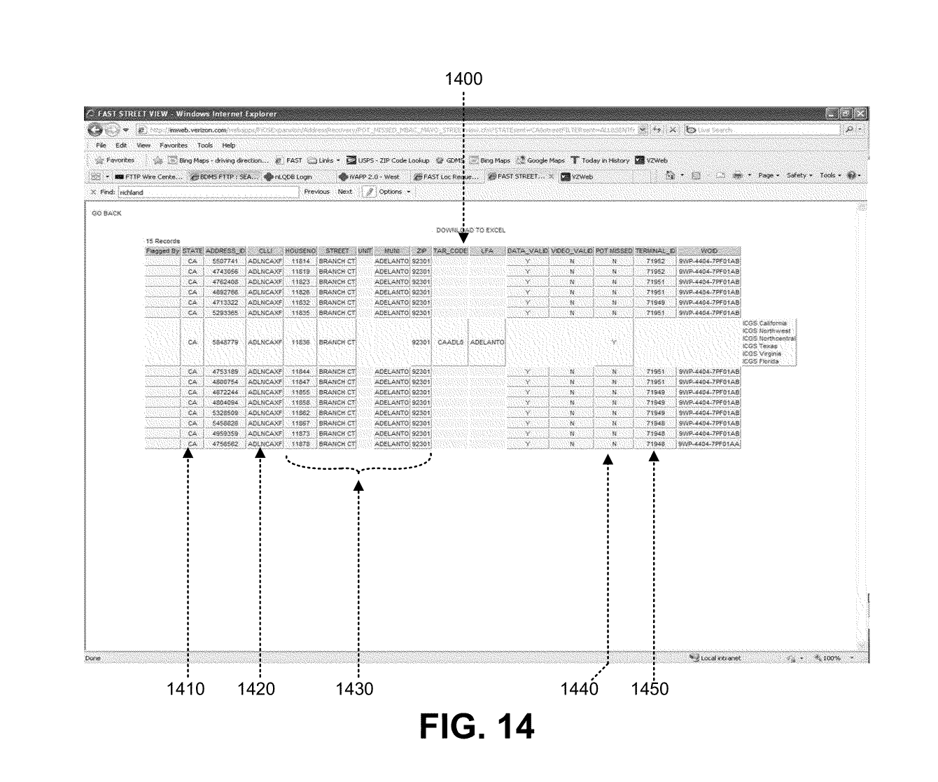

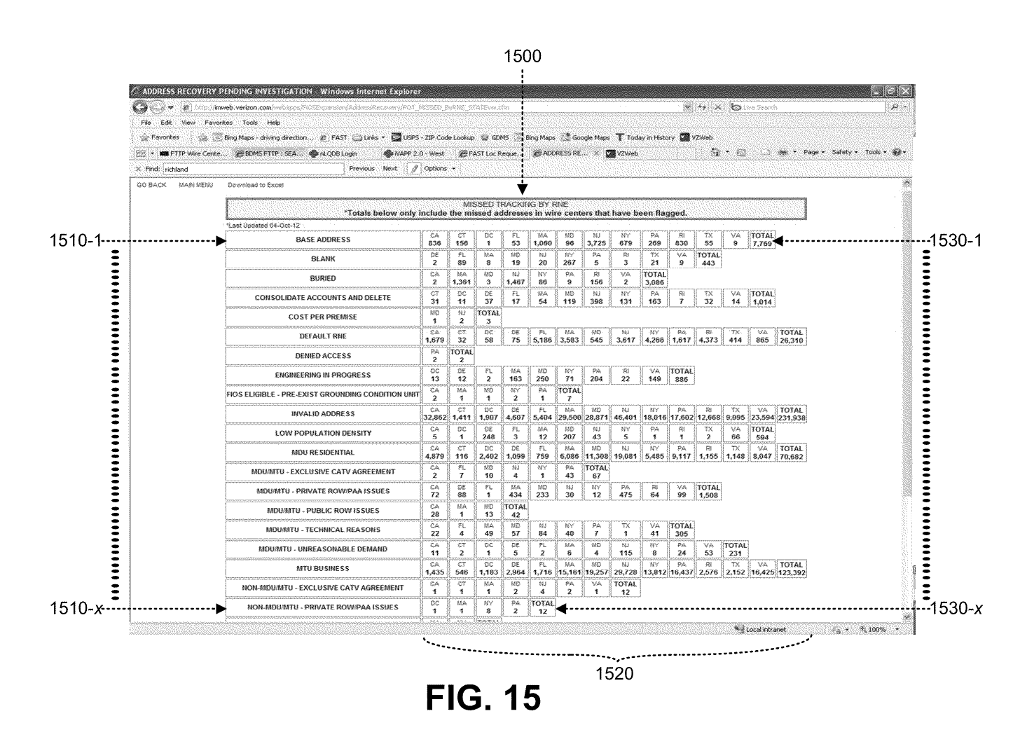

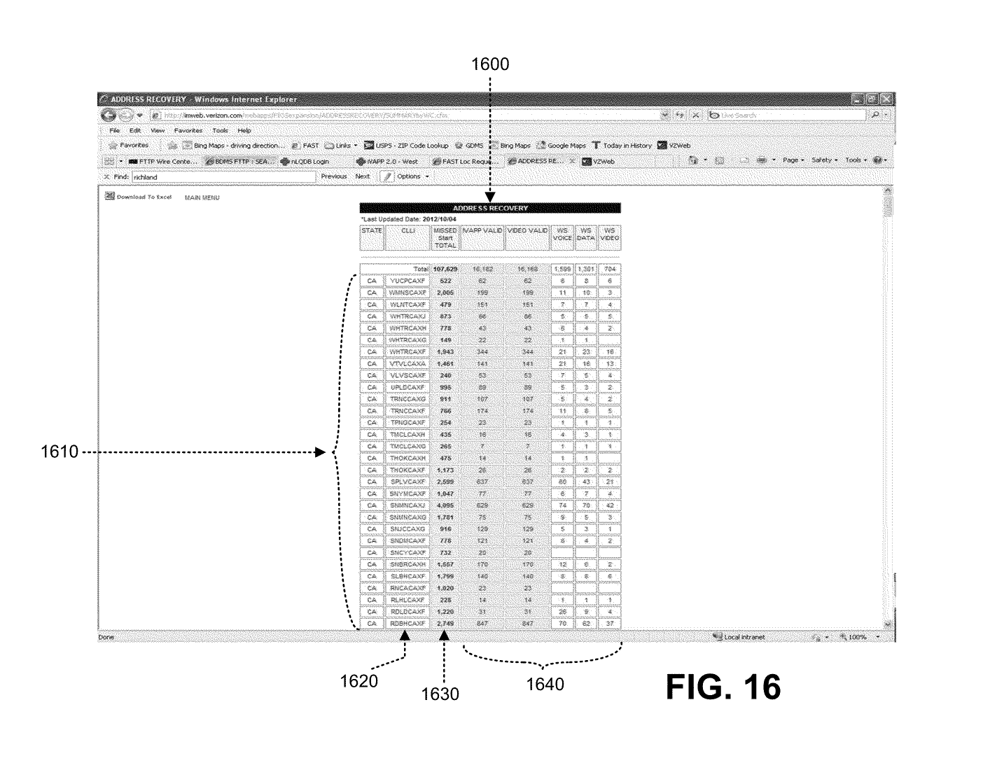

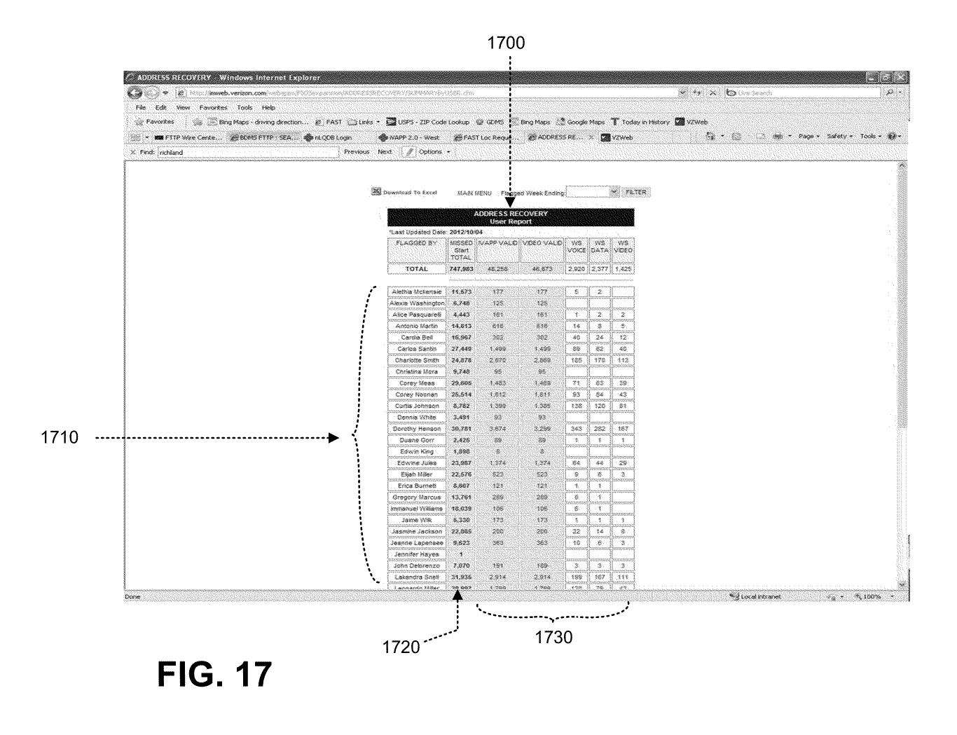

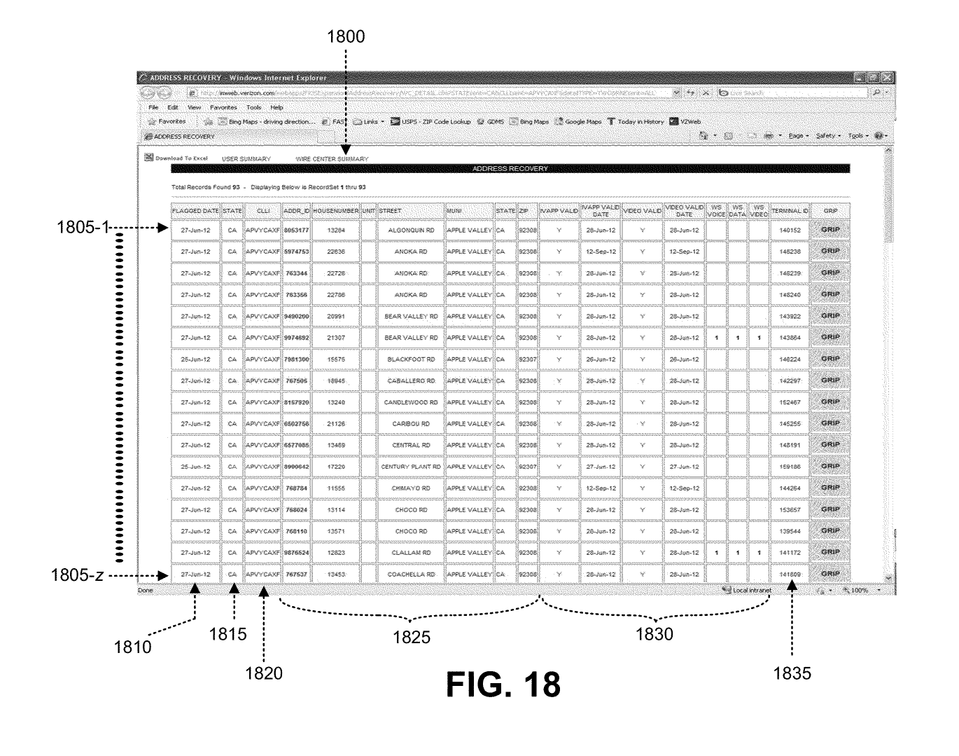

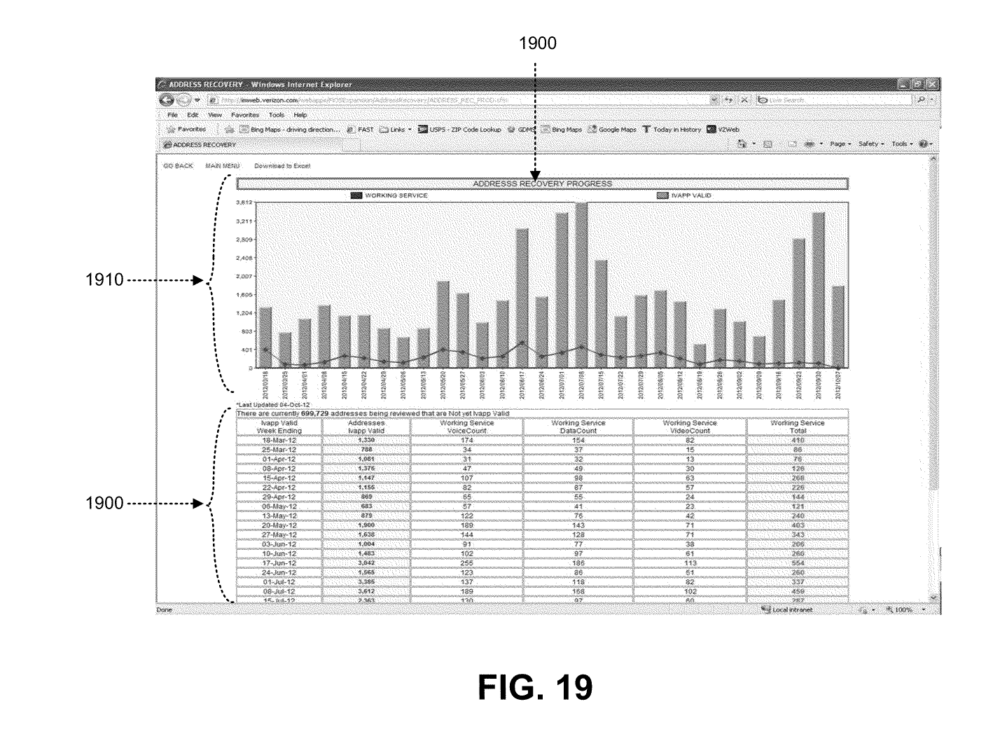

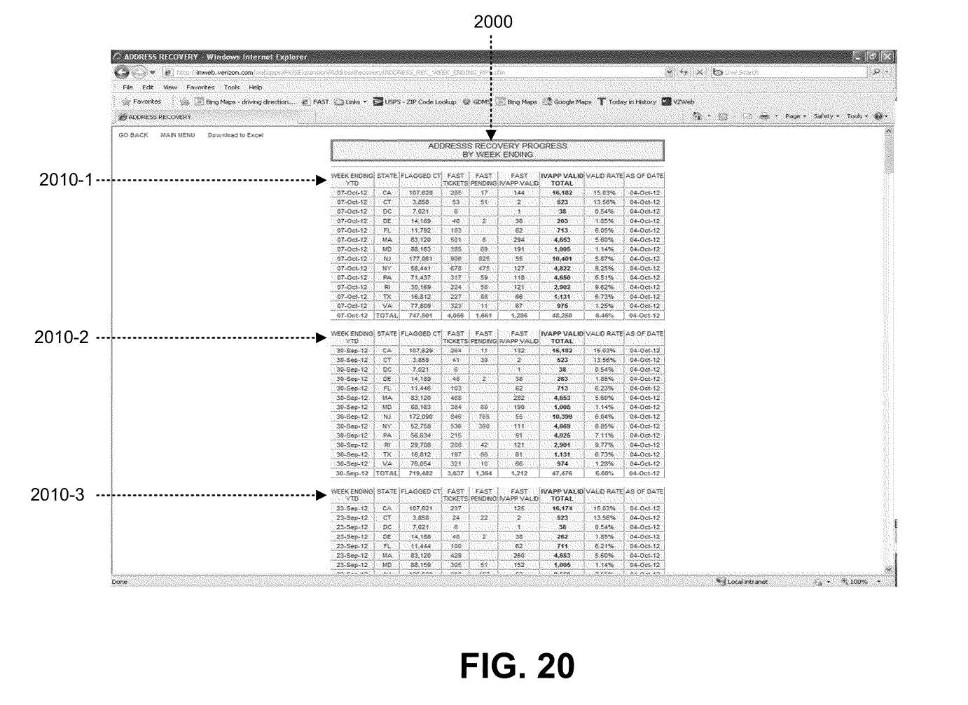

FIG. 7 is a flow diagram that illustrates an exemplary process for validating service addresses that have been previously identified as potentially being accessible to a service provider network. The exemplary process of FIG. 7 may be implemented by address recovery system 100. The exemplary process of FIG. 7 may occur subsequent to the execution of the exemplary process of FIG. 5. The description of the exemplary process of FIG. 7 below refers to the exemplary messaging diagram of FIG. 8, and the user interface examples of FIGS. 9-20.

The exemplary process may include address recovery system 100 receiving user selection of a geographic region associated with a service provider network (block 700). FIG. 9 depicts a user interface 900 that user 115 may use to access the address recovery tool provided by address recovery system 100. As shown, a link 910 in user interface 900 may be selected to access the address recovery tool, and obtain a state-by-state listing of aggregated numbers of addresses that are potentially accessible to the service provider network. FIG. 10 further depicts a table 1000 that is tabulated by state 1010 and further indicates a total number 1020 of addresses that are purportedly inaccessible to the service provider network, but that potentially may actually be accessible to the service provider network. User 115 may select any of the states listed in table 1000 to access, as shown in FIG. 11, a state table 1100 (e.g., California is shown) that is tabulated by state 1120, and wire center 1130. Table 1100 may indicate a total number of addresses that are purportedly inaccessible to the service provider network, but that potentially may actually be accessible to the service provider network for each wire center 1130. Each wire center 1130 in table 1100 may further include an address recovery comment section 1110 that user 115 may use to identify whether user 115 is currently recovering addresses within that wire center.

By selecting a wire center 1130 from table 1100, an address recovery interface 1200, as depicted in FIG. 12, may be presented to user 115 that includes entries 1215-1 through 1215-3 (only three entries shown in FIG. 12) for all of the addresses within the selected wire center. Each entry 1215 may include an address section 1210 which further may include an address type field 1220 (e.g., residential or business), a comments to engineering field 1225, and a create ticket button 1230. Field 1225 permits user 115 to enter comments directed at engineers who may attempt to connect the address to the service provider network. Create ticket button 1230 initiates the creation of a ticket to the engineers. Each entry 1215 may further include a “Reason Not Engineered (RNE)” field 1205 into which user 115 may enter information related to why the address will not be connected to the service provider network after validation of the address fails (i.e., indicates that the address is not accessible to the service provider network). Selection, by user 115, of an address associated with an entry 1215 in interface 1200 may select the geographic region associated with the service provider network (i.e., block 700 of FIG. 7). FIG. 8 depicts address recovery system 100 receiving a user selection 800 of geographic region from client 120.

Address recovery system 100 may generate a map of the geographic region with notations of residential and business addresses, service provider network information, and identified addresses that are potentially accessible to the service provider network (block 710). To generate the map, address recovery system 100 may use previously obtained geographic mapping data (e.g., from block 510 of FIG. 5), or may obtain current geographic mapping data for the geographic region from geographic mapping system 110. FIG. 8 depicts address recovery system 100 sending a map request 810 to geographic mapping system 110, and receiving a map 820 of the geographic region from geographic mapping system 110 in response to map request 810. FIG. 8 further depicts address recovery system 100 generating 830 a map of the geographic region with notations of addresses, service provider network information, and identified addresses that are potentially accessible to the service provider network.

Address recovery system 100 may present the map to the user for service address validation (block 720). FIG. 8 depicts address recovery system 100 sending a map 840 to a user at client 120. FIG. 13 further shows an exemplary map 1300 displayed in a user interface 1305 that corresponds to an address selected from user interface 1200 of FIG. 12. Map 1300 includes a legend 1310 that describes the components of the service provider network in a geographic area, such as, in an example where the service provider network is a fiber optic cable network, the geographic location and routing of cabling, the geographic location of distribution hubs, the geographic location of distribution terminals (e.g., drop terminals), and the geographic location and routing of copper cabling. Map 1300 further includes a superimposition of the components of the service provider network upon the view of the geographic area in geographic relation to the addresses within the geographic area. A visual analysis of map 1300, therefore, enables user 115 to determine if necessary network components are located at geographic locations that permit network access to one or more addresses previously identified as potentially being accessible to the service provider network (e.g., block 530 of FIG. 5). If the necessary network components are located at geographic locations that permit network access to one or more addresses previously identified as potentially being accessible to the service provider network, then user 115 may successfully validate those addresses by indicating (e.g., in comments field 1225 of interface 1200) that the service provider network is accessible to the one or more addresses. If the necessary network components are not located at geographic locations that permit network access to the one or more addresses, then user 115 may indicate (e.g., in RNE field 1205 of interface 1200) the reason why the service provider network is not accessible to the one or more addresses.

If the user validates one or more service addresses (YES—block 730), then address recovery system 100 may revise the service provider network information based on the validation of the one or more service addresses (block 740). FIG. 8 depicts address recovery system 100 receiving an indication of one or more service address validations 850 from client 120, and then revising 860 the service provider network information based on the indication of service address validations. If the user does not validate any service addresses (NO—block 730), then the exemplary process may return to block 700 with the receipt of a different geographic region associated with the service provider network.

User 115 may access various aspects of the revised service provider network information (from block 740) via a user interface at client 115. FIGS. 14-20 depict various exemplary interfaces that present various aspects of the revised service provider network information. For example, FIG. 14 depicts a table 1400 that presents revised service provider network information by state 1410, wire center 1420, and address 1430. For each address 1430, table 1400 presents validation information 1450 that identifies whether the address has been successfully validated or not (N equals “not successfully validated,” Y equals “successfully validated). FIG. 15 depicts a table 1500 that presents information describing all of the x different “reason not engineered” 1510-1 through 1510-x, and total numbers per state 1520 for each of the “reason not engineered” 1510. Table 1500 also presents accumulated totals 1530-1 through 1530-x, across all states for each respective “reason not engineered” 1510-1 through 1510-x.

FIG. 16 depicts a table 1600 that presents revised service provider network information by state 1610 and wire center 1620, with a total number 1630 of addresses potentially accessible to the service provider network per wire center. Table 1600 may further present information 1640 related to successfully validated addresses, including, for example, the total number of successfully validated addresses having voice, data and video.

FIG. 17 depicts a table 1700 that presents revised service provider network information for each user 115 validating addresses. As shown, table 1700 may present the information by user name 1710, with a starting total number 1720 of addresses potentially accessible to the service provider network for each user. Table 1700 may further present information 1720 related to successfully validated addresses per user, including, for example, the total number of successfully validated addresses having voice, data and video.

FIG. 18 depicts a wire center summary table 1800 that presents revised service provider network information by wire center and by address. As shown, table 1800 may include multiple entries 1805-1 through 1805-z, where each entry stores information related to a different address. For example, each entry 1805 of table 1800 may include a date field 1810, a state field 1815, a wire center field 1820, an address field 1825, validation information fields 1830, and a terminal ID field 1835. Date 1810 may indicate a date at which the address identified in address field 1825 is validated. State field 1815 identifies the state that the address identified in address field 1825 resides. Wire center field 1820 identifies the wire center that serves the address identified in address field 1825. Address field 1825 includes a unique address ID and a street address. Validation information fields 1810 include information associated with the validation of the address identified in address field 1825. The information includes whether the validated address has voice, data and/or video. Terminal ID field 1835 identifies a distribution terminal (e.g., a drop terminal) that has been determined to serve the address identified in address field 1825.

FIG. 19 depicts an address recovery progress dataset 1900 that tracks the progress of the recovery of service addresses (e.g., successful validation of the addresses) by one or more users. Dataset 1900 may include a bar chart 1910 that tracks the total number of addresses successfully validated over periods of time (e.g., per week). Dataset 1900 may further include a data table 1900 that includes a total count of addresses successfully validated over certain periods of time (e.g., per week). FIG. 20 depicts a table 2000 that tracks total address recovery per week. As shown, table 2000 includes weekly entries 2010-1 through 2010-3 (three weekly entries shown by way of example), where each weekly entry 2010 includes summarized information associated with address validation for that week.

Exemplary embodiments described herein enables users, via a user interface, to investigate addresses identified as potentially being accessible to a service provider network, such that the users may determine whether the addresses are actually accessible to the service provider network so communication services may be offered to the customers at those addresses. The address recovery system described herein, therefore, permits the network service provider to increase revenue by providing network service to addresses that may have been incorrectly identified as being inaccessible to the service provider network.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 5 and 7, the order of the blocks may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
obtaining, at a device, information associated with a service provider network from one or more network information systems;
identifying, by the device, addresses that purportedly are not accessible to the service provider network from the information associated with the service provider network;
obtaining, at the device, geographic mapping data including data associated with residential and business addresses;
comparing, by the device, the information associated with the service provider network, and the identified addresses that purportedly are not accessible to the service provider network, with the geographic mapping data; and
identifying, by the device, ones of the residential and business addresses purportedly not accessible to the service provider network, that potentially are accessible to the service provider network, based on the comparison.

2. The method of claim 1, further comprising:
organizing the identified ones of the residential and business addresses that potentially are accessible to the service provider network by at least one of state or wire center as tabulated data; and
presenting the tabulated data via a user interface.

3. The method of claim 2, wherein the tabulated data comprises data indicating a number of the identified ones of the residential and business addresses that potentially are accessible to the service network provider per state, per wire center, or per state and wire center.

4. The method of claim 1, wherein the service provider network comprises a communications network.

5. The method of claim 4, wherein the communications network comprises a cable network or a public switched telephone network (PSTN).

6. The method of claim 1, further comprising:
generating a map of a geographic region associated with a portion of the identified ones of the residential and business addresses, wherein the map notates residential and business addresses, service provider network information, and the portion of the identified ones of the residential and business addresses on the map;
presenting the map to a user for validation of the identified ones of the residential and business addresses;
receiving user input regarding validation of the identified ones of the residential and business addresses; and
revising the information associated with the service provider network based on the validation of the identified ones of the residential and business addresses.

7. The method of claim 6, wherein the user input regarding validation includes an indication that certain of the identified ones of the residential and business addresses have been determined to actually be accessible to the service provider network, or have been determined to not be accessible to the service provider network.

8. A device, comprising:
an input device configured to receive user input;
a communication interface; and
a processing unit configured to:
obtain, via the input device or the communication interface, information associated with a service provider network, wherein the service provider network comprises a communications network,
identify addresses that purportedly are not accessible to the service provider network from the information associated with the service provider network,
obtain, via the communication interface, geographic mapping data, including data associated with residential and business addresses,
compare the information associated with the service provider network, and the identified addresses that purportedly are not accessible to the service provider network, with the geographic mapping data, and
identify ones of the residential and business addresses purportedly not accessible to the service provider network, that potentially are accessible to the service provider network, based on the comparison.

9. A method, comprising:
receiving, at a network device from a user at a device, a selection of a geographic region associated with a service provider network;
generating, by the network device, a map of the geographic region, wherein the map includes notations of residential and business addresses, service provider network information, and addresses that purportedly are not accessible to the service provider network that potentially are actually accessible to the service provider network;
presenting the map to the user at the device;
receiving, at the network device from the user at the device, validation of one or more of the addresses that purportedly are not accessible to the service provider network; and
revising, by the network device, the service provider network information based on the validation of the one or more addresses.

10. The method of claim 9, wherein the service provider network comprises a communications network.

11. The method of claim 10, wherein the communications network comprises a cable network, or a public switched telephone network.

12. The method of claim 9, wherein the validation includes an indication that certain of the one or more addresses have been determined to actually be accessible to the service provider network, or have been determined to not be accessible to the service provider network.

13. The method of claim 12, wherein, if the validation indicates that the certain of the one or more addresses have been determined to not be accessible to the service provider network, then the validation further includes an indication of why the certain of the one or more addresses are not accessible to the service provider network.

14. The method of claim 9, wherein the service provider network information includes fiber optic cabling geographic routing information, distribution hub geographic location information, distribution terminal geographical location information, and copper cabling geographic routing information.

15. The method of claim 9, further comprising:
generating statistics related to the validation of the one or more addresses; and
presenting the statistics via a user interface.

16. The method of claim 15, wherein the generated statistics include at least one of the following:
a) a number of addresses validated by the user;
b) a number of addressed validated per wire center of the service provider network;
c) a number of addresses validated per state; or
d) a progress of validation of the one or more addresses over time.

17. A tangible non-transitory computer-readable medium storing instructions executable by at least one processor, the tangible non-transitory computer-readable medium comprising:
one or more instructions for receiving, from a user, a selection of a geographic region associated with a service provider network;
one or more instructions for generating a map of the geographic region, wherein the map includes notations of residential and business addresses, service provider network information, and addresses that purportedly are not accessible to the service provider network that potentially are actually accessible to the service provider network;
one or more instructions for presenting the map to the user;
one or more instructions for receiving, from the user, validation of one or more of the addresses that purportedly are not accessible to the service provider network, wherein the user validation includes an indication that certain of the one or more addresses have been determined to actually be accessible to the service provider network, or have been determined to not be accessible to the service provider network; and
one or more instructions for revising the service provider network information based on the user validation of the one or more addresses.

18. The tangible non-transitory computer-readable medium of claim 17, wherein, if the validation indicates that the certain of the identified ones of the residential and business addresses have been determined to not be accessible to the service provider network, then the validation further includes an indication of why the certain of the identified ones of the residential and business addresses are not accessible to the service provider network.

19. The tangible non-transitory computer-readable medium of claim 17, wherein the service provider network information includes fiber optic cabling geographic routing information, distribution hub geographic location information, distribution terminal geographical location information, and copper cabling geographic routing information.

20. The tangible non-transitory computer-readable medium of claim 17, further comprising:
one or more instructions for generating statistics related to the validation of the identified ones of the residential and business addresses; and
one or more instructions for presenting the statistics via a user interface.

21. The tangible non-transitory computer-readable medium of claim 20, wherein the generated statistics include at least one of the following:
a) a number of addresses validated by the user;
b) a number of addressed validated per wire center of the service provider network;
c) a number of addresses validated per state; or
d) a progress of validation of the identified ones of the residential and business addresses over time.
